(19) United States
(12) Patent Application Publication
(10) Pub. No.: US 2009/0312067 A1
(43) Pub. Date: Dec. 17, 2009

(54) System and Method of Escalating Call Alert Indications

(75) Inventor: Eskil Gunnar Ahlin, Veberod (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/138,524

(22) Filed: Jun. 13, 2008

(51) Int. Cl. H04B 1/38

(52) U.S. Cl. 455/567

(57) ABSTRACT

A wireless communications device, such as a cellular telephone, for example, receives incoming calls. A controller at the wireless communications device progressively escalates the call alert indications used to alert a user of an incoming call from a remote party based on an identity of the remote party, and on a cumulative number of times that the remote party has called the user without the user having answered the calls.

### TECHNICAL FIELD

The present invention relates generally to wireless communications devices, and particularly to methods of progressively escalating incoming call alert indications.

### BACKGROUND

Wireless communication devices, such as cellular telephones, for example, are very common. With such devices, users may enjoy being able to be in contact with most anyone most of the time. However, there are times when a user does not wish to be interrupted by an incoming message or call, such as when a user is in a meeting.

Conventionally, a user must manually change the type of call indication that alerts the user to an incoming call when in a meeting. For example, some users might navigate a menu system or depress a button on a keypad one or more times to change the incoming call alert indication from an audible ring tone to a tactile function. Still other users may have to turn off their phones altogether, as even the vibration caused by the tactile function generator could be too distracting in some cases. Such manual procedures, however, are not optimal in all cases.

Many users, while wishing not to be disturbed during a meeting, may nevertheless wish to receive emergency calls or important calls from particular people during the meeting. Further, users that alter the incoming call alert indications may forget to change them back once the meeting is over. In these cases, incoming calls may go unanswered by the user because the ringer or other alerting mechanism is turned off or not loud enough to alert the user.

### SUMMARY

The present invention is directed to a system and method of generating progressively more noticeable call alert signals to alert a user of a wireless communication device of an incoming call that may be urgent.

In one embodiment, a user's wireless communication device receives incoming calls from a remote party. Depending on whether the user is busy or in a meeting, for example, the user may not answer the incoming calls. Therefore, the user's wireless communication device progressively escalates the alert signals used to inform the user of an incoming call to make the call signals more noticeable to the user. With the progressive escalation technique of the present invention, a user will be able to determine whether a given remote party has an urgent or important a message.

More particularly, the user's wireless communication device maintains a cumulative count of the number of calls placed by the remote party to the wireless communication device. Each time an incoming call from the remote party goes unanswered by the user, the wireless communication device increments a counter value. If that counter value exceeds a predetermined threshold, the wireless communication device escalates the alert signal to be a signal that is more noticeable to the user. The alert signals may begin as relatively quiet alert signals; however, as the total number of unanswered calls for the remote party increases the alert signals may be more noticeable.

Therefore, one embodiment of the present invention is directed to a method of alerting a user of a wireless communication device to an incoming call. Particularly, the wireless communications device receives an incoming call from a remote party at a wireless communication device, and determines both an identity of the remote party placing the incoming call, and the total number of unanswered calls previously placed by the remote party and received at the wireless communication device. Based on these aspects, the device generates an alert signal responsive to the incoming call based on the identity of the remote party and the total number of unanswered calls previously placed by the remote party.

In one embodiment, the method further comprises incrementing the total number of unanswered calls if a user of the wireless communication device does not answer the incoming call, and resetting the total number of unanswered calls if the user answers the incoming call.

In another embodiment, the method further comprises calculating an elapsed time between a time of receipt of a previously unanswered call received from the remote party and a time of receipt for the incoming call, weighting an increment value based on the elapsed time, and incrementing the total number of unanswered calls with the weighted increment value.

In another embodiment, the method further comprises determining whether the total number of unanswered calls exceeds a predetermined threshold, and generating the alert signal based on the determination.

In another embodiment, the present invention compares the total number of unanswered calls to a predetermined value, calculates an elapsed time between a time of receipt of a previously unanswered call received from the remote party and a time of receipt for the incoming call, and determining that the total number of unanswered calls exceeds the predetermined threshold if the total number of unanswered calls exceeds the predetermined value, and if the elapsed time is less than a predefined time window.

In another embodiment, the present invention, the method further comprises selecting the alert signal responsive to the incoming call based on the total number of unanswered calls previously placed by the remote party and received at the wireless communication device.

The alert signals may be any known alert signals, and in one embodiment, the present invention escalates the alert signal from a first call alert level to a second call alert level if the total number of unanswered calls previously placed by the remote party and received at the wireless communication device exceeds a predetermined threshold.

The first call alert level and the second call alert level comprises a non-audible call alert indication, in which the second call alert level comprises an audible call alert indication.

On one embodiment, the present invention progressively escalates the alert signal based on the total number of unanswered calls placed by the remote party and received at the wireless communication device.

In another embodiment, a user's wireless communication device comprises 10. a transceiver configured to receive incoming calls from a remote party, a user interface configured to render alert signals to alert a user to an incoming call, and a controller. The controller determines an identity of the remote party placing the incoming call, determines a total number of unanswered calls previously placed by the remote party, and received at the wireless communication device, and generates a control signal responsive to the incoming call to control the user interface to render a selected alert signal based on the identity of the remote party and the total number of unanswered calls previously placed by the remote party.

In another embodiment, the controller increments the total number of unanswered calls if a user of the wireless communication device does not answer the incoming call, and resets the total number of unanswered calls if the user answers the incoming call.

In another embodiment, the controller calculates an elapsed time between a time of receipt of a previously unanswered call received from the remote party and a time of receipt for the incoming call, weights an increment value based on the elapsed time, and increments the total number of unanswered calls with the weighted increment value.

In another embodiment, the controller determines whether the total number of unanswered calls exceeds a predetermined threshold and selects the alert signal based on the determination.

In another embodiment, the controller compares the total number of unanswered calls to a predetermined value, calculates an elapsed time between a time of receipt of a previously unanswered call received from the remote party and a time of receipt for the incoming call, and determines that the total number of unanswered calls exceeds the predetermined threshold if the total number of unanswered calls exceeds the predetermined value, and if the elapsed time is less than a predefined time window.

In another embodiment, the controller selects an alert signal responsive to the incoming call based on the total number of unanswered calls previously placed by the remote party and received at the wireless communication device.

In another embodiment, the controller escalates the alert signal from a first call alert level to a second call alert level if the total number of unanswered calls previously placed by the remote party and received at the wireless communication device exceeds a predetermined threshold.

In one embodiment, the first call alert level comprises a non-audible call alert indication, and the second call alert level comprises an audible call alert indication.

In one embodiment, the controller progressively escalates the alert signal based on the total number of unanswered calls placed by the remote party and received at the wireless communication device.

### BRIEF DESCRIPTION OF THE DRAWINGS

FIG. 1 is a block diagram illustrating some of the component parts of a wireless communication device configured according to one embodiment of the present invention.

FIG. 2 is a perspective view of a wireless communication device configured according to one embodiment of the present invention.

FIG. 3 is a flow chart illustrating a method of progressively escalating incoming call alert indications according to one embodiment of the present invention.

FIG. 4 is a flow chart illustrating a method of progressively escalating incoming call alert indications according to another embodiment of the present invention.

FIG. 5 is a flow chart illustrating a method of progressively escalating incoming call alert indications according to another embodiment of the present invention.

### DETAILED DESCRIPTION

The present invention is directed to a system and method of alerting a user of a wireless communication device to an incoming call or message. When the wireless communication device receives an incoming call, the device will attempt to alert the user by rendering a call alert indication. The user of the device may not answer the incoming call because the user is busy, or in a meeting, or for any number of other reasons.

If a call from a given remote party is urgent, however, it is likely that the remote party will call again within some short period of time. Therefore, the wireless communication device tracks the identities of the remote parties that are calling the user, and the total number of times that a given remote party calls without the user answering the call. The call alert indications rendered for a given remote party may begin, for example, as relatively quiet or unobtrusive call alerts. As the total number of unanswered calls from the given remote party increases, the user's wireless communication device progressively escalates the alert indications so that they become more noticeable to the user.

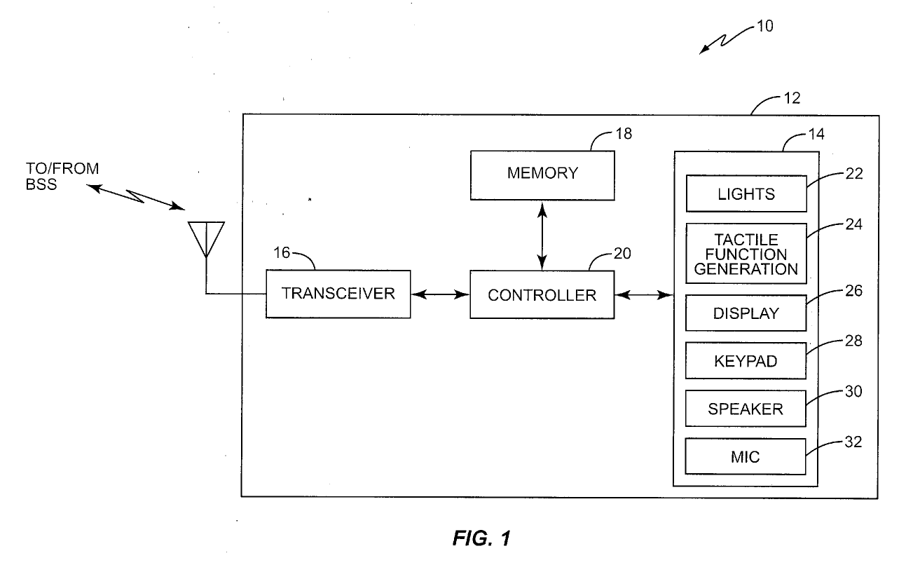

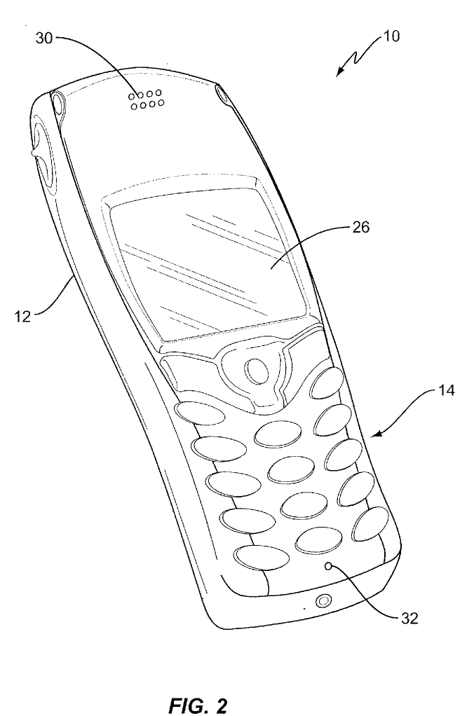

Turning now to the figures, the wireless communication device may be, for example, a cellular telephone 10 such as the one seen in FIGS. 1 and 2. Cellular telephone 10 typically includes a housing 12, a User Interface (UI) 14, a long-range transceiver 16, a memory 18, and a controller 20. As seen in FIG. 1, the controller 20 is configured to communicatively connect and control the operation of the memory 18, the transceiver 16, and the UI 14.

The UI 14 facilitates user interaction with the cellular telephone 10 and may include any known type of user interface. In this embodiment, however, the UI 14 comprises one or more lighting elements 22, such as backlighting elements, a tactile function generator 24 to vibrate the cellular telephone 10, a display 26, a keypad 28, one or more speakers 30, and a microphone 32.

As is known in the art, the user can control the communication functions of cellular telephone 10 via the UI 14, as well as other functions and features not specifically shown here. For example, the user may use the UI 14 to navigate menu systems and to selectively enter the telephone numbers of remote parties and other commands. However, according to the present invention, the UI 14 may also be employed to alert the user to incoming calls. Particularly, as described in more detail later, different interfaces of the UI 14 such as the lighting elements 22, the tactile function generator 24, and the speaker 30, may be used to render alert indications that indicate a call of possibly particular importance from a particular calling party.

The transceiver 16 allows the user to communicate voice and/or data with one or more remote parties over long and short distances via a wireless communications network. The transceiver 16 may be, for example, a cellular radio transceiver operating according to any known wireless standard. Some examples of suitable standards include, but are not limited to, Wideband Code Division Multiple Access (WCDMA) and Global System for Mobile communications (GSM) standards.

Memory 18 represents the entire hierarchy of memory in the cellular telephone 10, and may include both random access memory (RAM) and read-only memory (ROM). Computer program instructions and data required for operation are stored in non-volatile memory, such as EPROM, EEPROM, and/or flash memory, while data such as address books and other user data are stored in volatile memory.

In one embodiment of the present invention, the memory 18 stores programs and data that control how an interface of the UI 14 will be used. Such programs and data include, for example, different patterns for controlling the lights 22 or tactile function generator 24, or the loudness of speaker 30. Memory 18 may also store a call record having information about a call from a particular remote party. There may be one call record for each remote party. The call record information may comprise, for example, a total number of times that the cellular telephone 10 has received an incoming call from a given remote party without the user having answered the calls. The information may also include a time of receipt for a call from the remote party. As described in more detail later, the call record information may be used to progressively escalate an alert indication rendered to the user to let the user know of a possibly urgent incoming call.

The controller 20, which may be a microprocessor, controls the operation of the cellular telephone 10 based on application programs and data stored in memory 18. The control functions may be implemented in a single digital signal microprocessor, or in multiple digital signal microprocessors. In one embodiment of the present invention, controller 20 generates and maintains the call record information. If the controller 20 determines that (1) the remote party has called the user a certain number of times over a specified time frame, and that (2) none of those calls were answered by the user, the controller 20 generates control signals to escalate the type of call indication used to alert the user. This helps the user to understand that a given call may be an important call.

By way of example, a user in a meeting may not wish to be disturbed, and thus, not answer incoming calls. Therefore, upon detecting a first incoming call from a given calling party, the controller 20 might generate a control signal to cause the lighting elements 22 to flash on and off according to some predetermined pattern. Such an unobtrusive call alert indication lets the user know that an incoming call has arrived without unnecessarily interrupting the meeting with loud ring tones. However, if the calling party has an important message to tell the user, it is likely that the calling party will retry the call to the user within a short period of time. Thus, upon receiving a second incoming call from the given calling party, the controller 20 will use a more forceful alert indication to alert the user to the incoming call. For example, the controller 20 might generate control signals to activate the tactile function generator, or flash the backlighting and activate the tactile function generator. If the calls still remain unanswered, subsequent calls received from the calling party might cause the controller 20 to generate control signals to render ring tones at varying levels of loudness, or to activate multiple alert indications. The idea is to render or activate alert indications that are progressively more noticeable to the user so that the user will become aware of the possible importance of a call from a particular calling party.

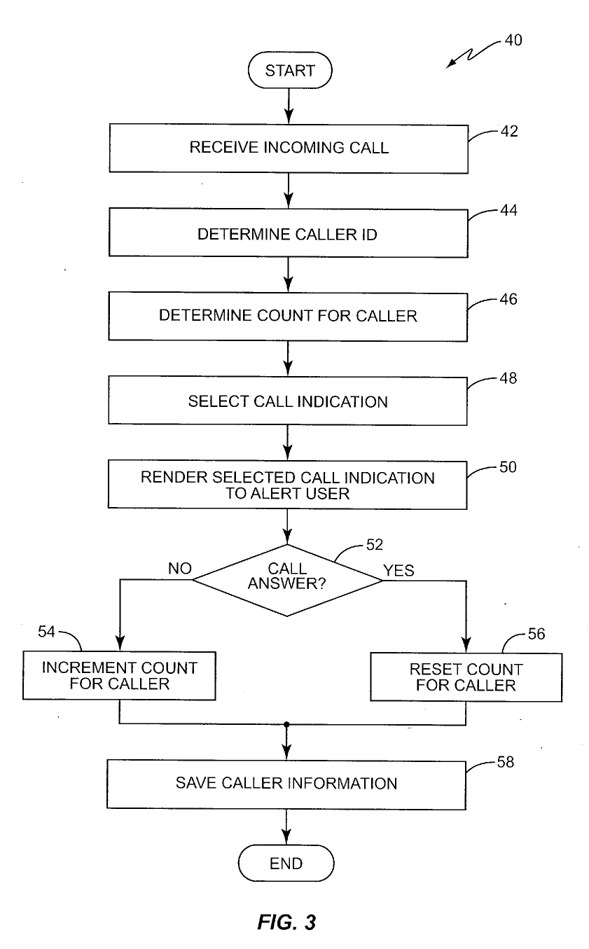

FIG. 3 is a flow diagram that illustrates a method 40 of performing one embodiment of the present invention. For illustrative purposes only, FIG. 3 assumes that the calling party (referred to herein as “Party A”) has placed a plurality of calls to the receiving user (refereed to herein as “Party B”), none of which have been answered by the receiving user.

Method 40 begins when Party B's cellular telephone 10 receives an incoming call from Party A (box 42). The controller 20 is configured to determine the identity of the calling party (box 44), and a total call count for the identified calling party (box 46). For example, the controller 20 might obtain this information by retrieving the call record for Party A from memory 18. The controller 20 then selects the corresponding call alert indication based on the identity of the calling party (i.e., Party A) and the total call count for Party A (box 48), and renders the selected call indication to alert Party B to the incoming call (box 50). If Party B answers the call, (box 52), the controller resets the total call count for Party A to zero and saves the call record in memory 18 (box 58). Otherwise, the controller 20 will increment the total call count for Party A and saves the call record in memory 18 (box 58).

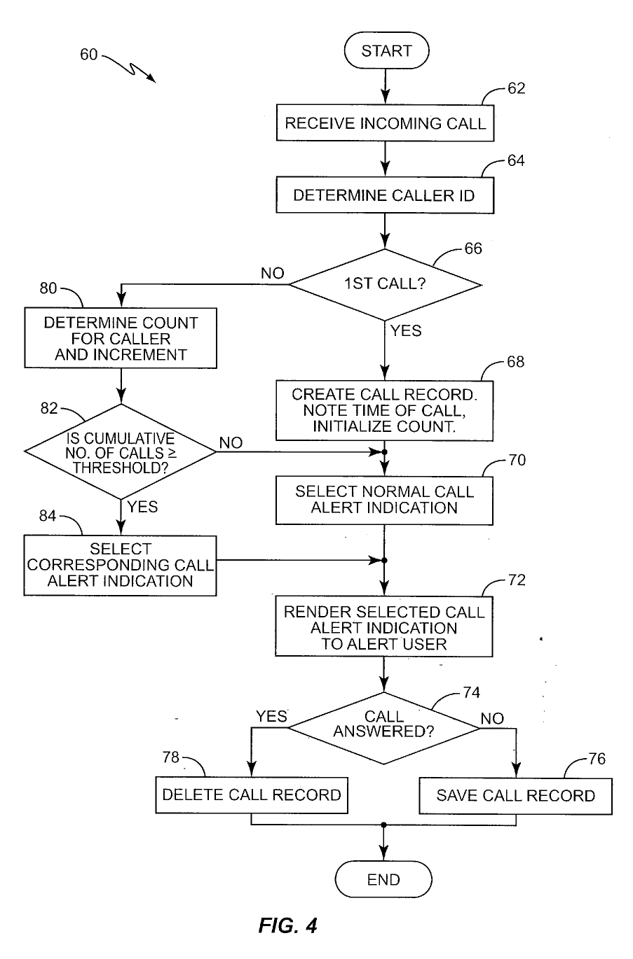

FIG. 4 is a flow diagram illustrating a method 60 of performing another embodiment of the present invention. In this embodiment, the present invention will consider the identity of the calling party, and the total number of calls from the calling party that go unanswered within a predetermined time window.

Method 60 begins when Party B receives an incoming call from Party A (box 62). Controller 20 will determine the identity of Party A using, for example, the caller ID information received with the incoming call page (box 64). The controller 20 will then determine whether a call record for Party A exists in memory 18 (box 66). If none exists, it might be the first call from Party A received by Party B. The controller 20 will then create the call record for Party A, and include the time of receipt for the incoming call and initialize the total call count (box 68). Controller 20 can then select a normal call alert indication (box 70), which can be a user-defined call alert indication pre-set by Party B, and render it to alert Party B (box 72). As above, if Party B answers the call (box 74), the controller 20 will delete the call record for Party A (box 78). Otherwise, the controller 20 will save the call record in memory 18 (box 76).

If the controller 20 determines that Party A has previously placed calls to Party B that went unanswered (i.e., a call record for Party A already exists) (box 66), then the controller 20 will retrieve and increment the total call count for Party A (box 80). Next, the controller 20 will determine whether that total number of calls exceeds some predetermined threshold (box 82). For example, Party B might set a call threshold specifying the total number of calls that can be received from Party A within a specified time window (e.g., 5 calls within 5 minutes).

The controller might perform this check by determining an elapsed time between the first call from Party A and the current call. For example, the controller 20 could calculate a time difference between the receipt time of the first call (i.e., the time saved in the call record) and the receipt time of the current incoming call. If that time difference is greater than the predetermined time window, or if the total number of calls does not exceed or equal the call threshold, then the controller 20 will select the user-defined call alert indication as previously stated (box 70). However, if the time difference is less than the predetermined time window, and if the total number of calls exceeds or equals the call threshold, then the controller 20 will progressively escalate the call alert indication. For example, the controller 20 could select another call alert indication based on the total call count for Party A (box 84). The controller 20 then renders the selected call alert indication to Party B (box 72), and saves or deletes the call record for Party A depending on whether Party B answers the call (boxes 74, 76, 78).

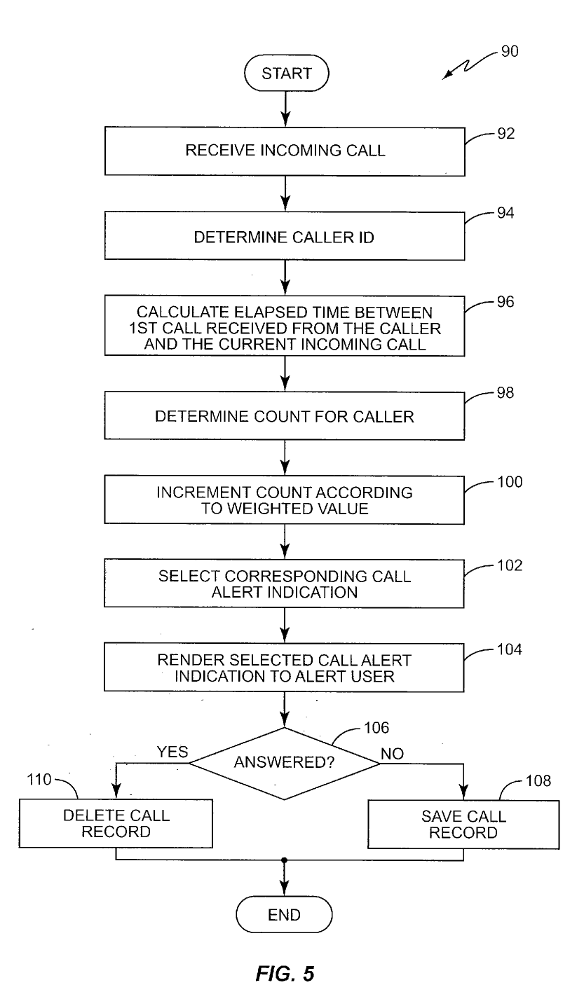

FIG. 5 is a flow diagram illustrating another embodiment of the present invention. Particularly, the embodiment of FIG. 5 uses a weighted value for incrementing the total call count for a given calling party. The weighted value reflects the total number of calls received from the same calling within a period of time that go unanswered by the user. In FIG. 5, it is assumed that Party A has called Party B multiple times without Party B having answered the calls.

Method 90 begins when Party B receives an incoming call from Party A (box 92). The controller 20 identifies the calling party as Party A using, for example, the call information received with the incoming call (box 94). The controller 20 then calculates an elapsed time between the time of receipt for the first call received from Party A and the time of receipt for the current incoming call (box 96). The controller 20 will then determine the total call count for Party A (box 98) and increment the count according to a weighted value (box 100).

The value may be, for example, time-weighted such that shorter elapsed time differences are afforded a higher weight than are longer time differences. Providing the shorter time differences a greater weight effectively increases the increment value, thereby effectively increasing the level of escalation.

Once calculated, the controller 20 selects a call alert indication that corresponds to the newly calculated and weighted total count (box 102), and renders the call alert indication to Party B (box 104). The controller 20 will either save or delete the call record for Party A depending on whether Party B answers the call (boxes box 106, 108, 110).

As previously stated, each call record is associated with a particular calling party and includes a counter value that corresponds to a specific alert indication level. The following table provides an example of how the values might map to specific alert indications.

TABLE 1
Alert Indication Level Mapping

| LEVEL | TYPE OF ALERT INDICATION TO RENDER |
|---|---|
| 1 | Flash Backlighting |
| 2 | Vibrate |
| 3 | Flash Backlighting + Vibrate |
| 4 | Low Audio Ring Tone |
| 5 | Loud Audio Ring Tone |

Thus, as seen in Table 1, memory 18 might store a table that identifies the alert level-to-call alert indication mapping. As seen here, alert indications are relatively unobtrusive for the lower level values, but increase to become more noticeable with the higher level values.

It should be understood to those skilled in the art that additional alert indication level values and/or corresponding alert indications may be specified by the user. For example, a user may specify an alert level-call indication mapping table for individuals, or to cover all calling parties. Similarly, he user might set a single call threshold for all users, or multiple call thresholds for multiple calling parties. Thus, the user might escalate calls to more important call alert indications faster for some calling parties than for others.

Those skilled in the art should appreciate that the previous embodiments illustrate the present invention in terms of a cellular telephone 10. However, this is for illustrative purposes only. The present invention may be employed with any device capable of communications with one or more remote parties. Such devices include, but are not limited to, cellular telephones, satellite telephones, personal communication services (PCS) devices, personal data assistants (PDAs), palm-top computers, and the like.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of alerting a user of a wireless communication device to an incoming call comprising:
receiving an incoming call from a remote party at a wireless communication device;
determining an identity of the remote party placing the incoming call;
determining a count of unanswered calls previously placed by the remote party, and received at the wireless communication device; and
generating an alert signal responsive to the incoming call based on the identity of the remote party and the count of unanswered calls previously placed by the remote party.

2. The method of claim 1 further comprising:
incrementing the count of unanswered calls if a user of the wireless communication device does not answer the incoming call; and
resetting the count of unanswered calls if the user answers the incoming call.

3. The method of claim 2 further comprising:
calculating an elapsed time between a time of receipt of a previously unanswered call received from the remote party and a time of receipt for the incoming call;
weighting an increment value based on the elapsed time; and
incrementing the count of unanswered calls with the weighted increment value.

4. The method of claim 1 further comprising
determining whether the count of unanswered calls exceeds a predetermined threshold; and
generating the alert signal based on the determination.

5. The method of claim 4 wherein determining whether the count of unanswered calls exceeds a predetermined threshold comprises:
comparing the count of unanswered calls to a predetermined value;
calculating an elapsed time between a time of receipt of a previously unanswered call received from the remote party and a time of receipt for the incoming call; and
determining that the count of unanswered calls exceeds the predetermined threshold if the count of unanswered calls exceeds the predetermined value, and if the elapsed time is less than a predefined time window.

6. The method of claim 1 further comprising selecting the alert signal responsive to the incoming call based on the count of unanswered calls previously placed by the remote party and received at the wireless communication device.

7. The method of claim 6 wherein selecting the alert signal comprises escalating the alert signal from a first call alert level to a second call alert level if the count of unanswered calls previously placed by the remote party and received at the wireless communication device exceeds a predetermined threshold.

8. The method of claim 7 wherein the first call alert level comprises a non-audible call alert indication, and wherein the second call alert level comprises an audible call alert indication.

9. The method of claim 7 wherein escalating the alert signal comprises progressively escalating the alert signal based on the count of unanswered calls placed by the remote party and received at the wireless communication device.

10. A wireless communication device comprising:
a transceiver configured to receive incoming calls from a remote party;
a user interface configured to render alert signals to alert a user to an incoming call; and
a controller configured to:
determine an identity of the remote party placing the incoming call;
determine a count of unanswered calls previously placed by the remote party, and received at the wireless communication device; and
generate a control signal responsive to the incoming call to control the user interface to render a selected alert signal based on the identity of the remote party and the count of unanswered calls previously placed by the remote party.

11. The device of claim 10 wherein the controller is further configured to:
increment the count of unanswered calls if a user of the wireless communication device does not answer the incoming call; and
reset the count of unanswered calls if the user answers the incoming call.

12. The device of claim 11 wherein the controller is further configured to:
calculate an elapsed time between a time of receipt of a previously unanswered call received from the remote party and a time of receipt for the incoming call;
weight an increment value based on the elapsed time; and
increment the count of unanswered calls with the weighted increment value.

13. The device of claim 10 wherein the controller is further configured to:
determine whether the count of unanswered calls exceeds a predetermined threshold; and
select the alert signal based on the determination.

14. The device of claim 13 wherein the controller is further configured to:
compare the count of unanswered calls to a predetermined value;
calculate an elapsed time between a time of receipt of a previously unanswered call received from the remote party and a time of receipt for the incoming call; and
determine that the count of unanswered calls exceeds the predetermined threshold if the count of unanswered calls exceeds the predetermined value, and if the elapsed time is less than a predefined time window.

15. The device of claim 10 wherein the controller is further configured to select an alert signal responsive to the incoming call based on the count of unanswered calls previously placed by the remote party and received at the wireless communication device.

16. The device of claim 15 wherein the controller is further configured to escalate the alert signal from a first call alert level to a second call alert level if the count of unanswered calls previously placed by the remote party and received at the wireless communication device exceeds a predetermined threshold.

17. The device of claim 16 wherein the first call alert level comprises a non-audible call alert indication, and wherein the second call alert level comprises an audible call alert indication.

18. The device of claim 16 wherein the controller is further configured to progressively escalate the alert signal based on the count of unanswered calls placed by the remote party and received at the wireless communication device.
